(19) United States
(12) Patent Application Publication
(10) Pub. No.: US 2005/0068158 A1
(43) Pub. Date: Mar. 31, 2005

(54) Whistle with light emitting device

(76) Inventor: Lo-Pin Wang, Taichung (TW)

Correspondence Address: BACON & THOMAS, PLLC, 625 SLATERS LANE, FOURTH FLOOR, ALEXANDRIA, VA, 22314, US

(21) Appl. No.: 10/671,486

(22) Filed: Sep. 29, 2003

(51) Int. Cl. G08B 27/00

(52) U.S. Cl. 340/326

(57) ABSTRACT

A whistle has a whistle member having a mouthpiece at a front thereof, a chamber therein, a passage communicated with the chamber, and an outlet at a sidewall of the chamber, and a light emitting device provided on the whistle member, which has a lamp, a battery and a switch device, wherein the lamp is conducted with the battery and the switch is provided at between the lamp and the battery to turn the lamp on or off.

### BACKGROUND OF THE INVENTION

1. Field of the Invention

The present invention relates to a whistle, and more particularly to a whistle with a light emitting device.

2. Description of the Related Art

Women or children usually carry devices for self-deference, such as whistle, stun gun or pepper gas spray and so on. All of them have function of deference or call for help. The stun gun and the pepper gas spray themselves are dangerous for children. The whistle is the most popular device for both women and children to call for help or to scare the bad guy off while emergency. The conventional whistle only has function of making noise that might be not keep him or her from danger and the one he who hear the noise of the whistle might have problem to identify the location at a dark place.

### SUMMARY OF THE INVENTION

The primary objective of the present invention is to provide a whistle, which has functions of making noise and emitting light while he/she is in danger.

According to the objective of the present invention, a whistle comprises a whistle member having a mouthpiece at a front thereof, a chamber therein, a passage communicated with the chamber, and an outlet at a sidewall of the chamber, and a light emitting device provided on the whistle member, which has a lamp, a battery and a switch device, wherein the lamp is conducted with the battery and the switch is provided at between the lamp and the battery to turn the lamp on or off.

### BRIEF DESCRIPTION OF THE DRAWINGS

FIG. 1 is a perspective view of a preferred embodiment of the present invention, and

FIG. 2 is an exploded view of the preferred embodiment of the present invention.

### DETAILED DESCRIPTION OF THE INVENTION

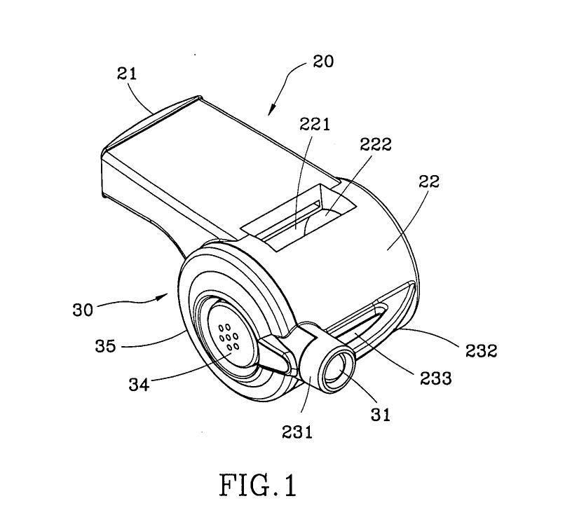

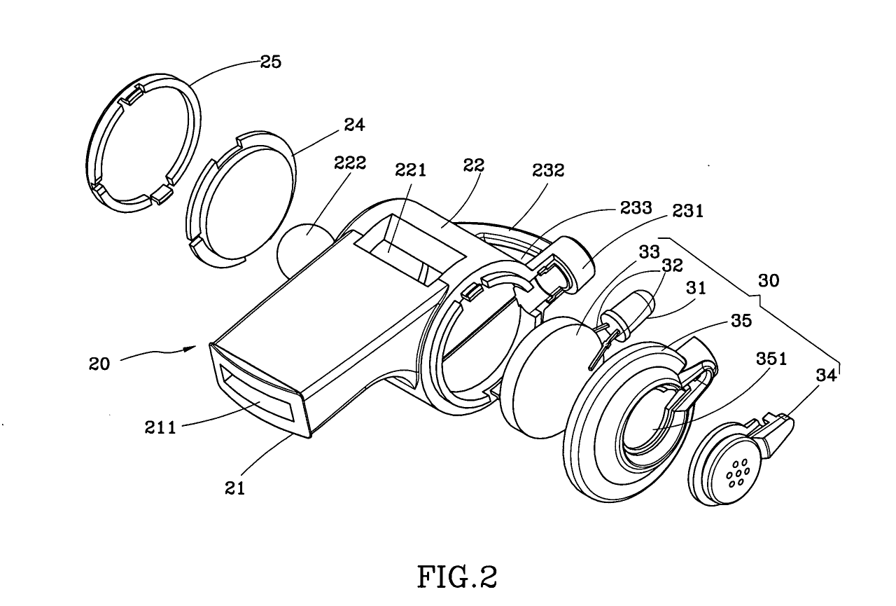

As shown in FIG. 1 and FIG. 2, a whistle 20 of the preferred embodiment of the present invention comprises:

A whistle member 20 has a mouthpiece 21 at a front thereof, a chamber 22 therein, a passage 211 in the mouthpiece 21 and communicated with the chamber 22, an outlet 221 on a sidewall of the chamber 22 and a ball received in the chamber 22. The chamber 22 is open at opposite lateral sides and at the left open of which is an annular rib at a periphery thereof to form a recess 23 therewithin. A tube 231 is provided on the whistle member 20 having an end communicated with the recess 23. The whistle member 20 is provided with a hanger 232 at a rear thereof, wherein the hanger 232 has opposite ends connected with the rear of the whistle member 20 and the tube 231. Between the hanger 232 and the whistle member 20 is an opening for tying a rope (not shown). A round board is provided at the right open of the chamber 22 to seal it and a cover 25 is detachably provided on the board 24. Between the board 24 and the cover 25 is a room 24 in which small goods can be stored.

A light emitting device 30 has a lamp 31, which is a light emitting diode (LED) in the present invention, to be received in the tube 231 and a battery 32 received in the recess 23 wherein the battery 32 is arranged between two terminals of the LED lamp 31. The LED lamp 31 has one terminals contacted with an anode terminal of the battery 32 and has the other one not contacted with the cathode terminal of the battery 32 at initial. A cover 35 is detachably provided on the whistle member 20 to cover the battery 32 and parts of the LED lamp 31. The cover 35 has an aperture 351 at a center thereof. A switch device 34 is provided to turn the LED lamp 31 on or to turn it off. In the present preferred embodiment, the switch device 34 is a button provided in the aperture 351 of the cover 35. The button 34 is pivoted on the cover 35 to move the terminal of the LED lamp 31 touching the battery 32. There are many conventional alternate devices of the switch device 34 and they should be the scope of the present invention.

The button 34 is pressed to bend the terminal of the LED lamp 31 to make the terminal touching the cathode terminal of the battery 32 such that the LED lamp 31 lights. While the button 34 is no longer pressed, the terminal of the battery 32 recovers and pushes the button 34 outwards. Under such condition, the terminal of the battery 32 does not touch the battery 32 and the LED lamp 31 does not light.

The whistle of the present invention serves the function of provides both of noise and light emission while the user needs help. The light might scare the bad guy off and make other people find the location of the user easier in a dark place. The light emitting device 30 of the whistle of the present invention also can light the key hole and some other places that needs to be lighted.

The types of the whistle and the lamp are not limited in the perspective view of the drawings. They should be replaced with a suitable type of the whistle and the lamp, such as a whistle of high tone to broadcast the noise further and a lamp of high luminous intensity. Such a whistle of the present invention is suitable for the climber calling for help at mountain.

1. A whistle, comprising:
a whistle member having a mouthpiece at a front thereof, a chamber therein, a passage communicated with the chamber, and an outlet at a sidewall of the chamber, and
a light emitting device provided on the whistle member, which has a lamp, a battery and a switch device, wherein the lamp is conducted with the battery and the switch is provided at between the lamp and the battery to turn the lamp on or off.

2. The whistle as defined in claim 1, wherein the switch has a button provided on the whistle member.

3. The whistle as defined in claim 1, wherein the lamp is a light emitting diode.

4. The whistle as defined in claim 1, further comprising a ball received in the chamber of the whistle member.

5. The whistle as defined in claim 1, wherein the whistle member is detachably provided with a cover and between the cover and the whistle member is a room.

6. The whistle as defined in claim 1, wherein the chamber of the whistle member is open at a lateral side thereof and a board is provided on the whistle member to seal the chamber and a cover is detachably provided on the whistle member covering the board and between the board and the cover is a room.

7. The whistle as defined in claim 1, wherein the whistle member has a recess in which the battery is mounted and a cover covering the battery.

8. The whistle as defined in claim 7, wherein the switch device is provided on the cover.

9. The whistle as defined in claim 1, wherein the whistle member has a tube in which the lamp is mounted.

10. The whistle as defined in claim 9, wherein the whistle member has hanger, which has an end thereof connected with the whistle member and the other end thereof connected with the tube.
